(19) United States
(12) Patent Application Publication
(10) Pub. No.: US 2012/0160369 A1
(43) Pub. Date: Jun. 28, 2012

(54) Vent and drain

(76) Inventor: Frank James Reeder, Charlotte, NC (US)

(21) Appl. No.: 12/661,892

(22) Filed: Dec. 27, 2010

(51) Int. Cl. B67C 11/00

(52) U.S. Cl. 141/331

(57) ABSTRACT

The Vent & Drain provides an improved funnel with a built-in air vent. The invention includes a small air vent along one entire side of the funnel. The included air vent provides an escape for air during pouring which creates a smoother flow of the liquid. The improved flow will prevent liquid from erupting, stop splashes, spills, and or bubbling which will shorten the time it would normally take to pour a liquid. The Vent & Drain also promotes a cleaner environment due to less spillage of liquid.

When using an existing funnel pouring liquid can be a little messy. Air will try to vent when liquid enters the void area. The air will vent through the funnel causing the liquid to bubble or erupt, spilling the liquid on the outer edge of the funnel.

In accordance with the present invention the venting funnel will avoid the spills and splashes. Creating a cleaner environment.

### BRIEF DESCRIPTIONS OF THE DRAWINGS

The forgoing features and advantage of the invention can be seen from the following drawings.

FIG. 1—Give a view of the vented tube from the side.

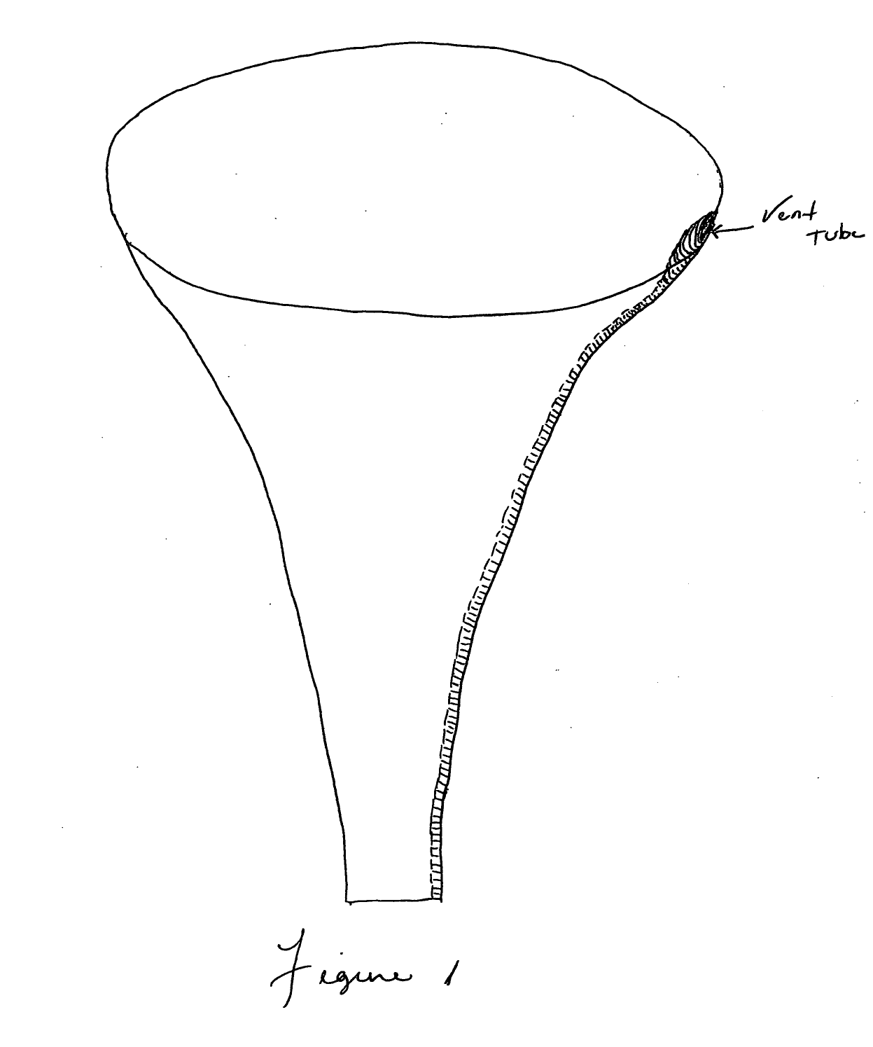

FIG. 2—Give a view of the vented tube from the front.

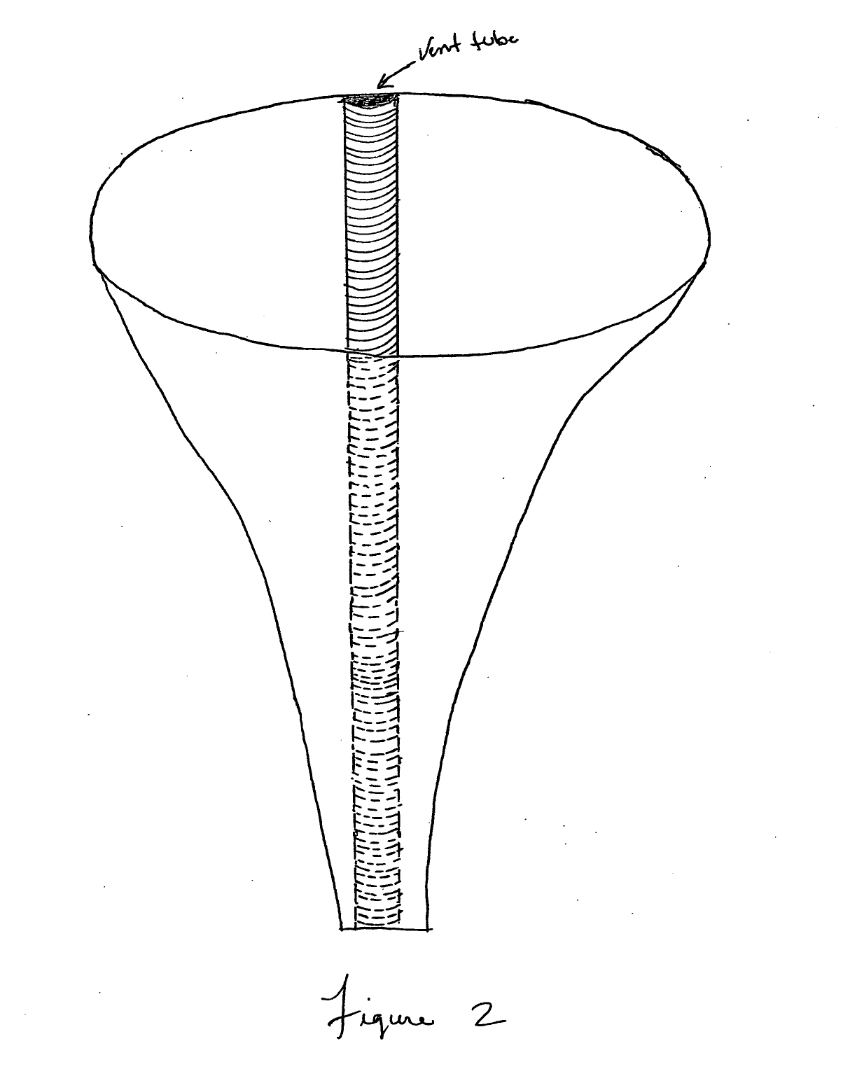

1. A vent and drain is a pouring apparatus; the apparatus comprising of a funnel, (see FIG. 2), with a small built-in air vent along one entire side of the funnel.

2. The apparatus is used to prevent liquid from bubbling, spilling, or erupting during pouring.

3. The apparatus helps to promote a cleaner environment.

4. The apparatus speeds up the pouring of liquid, which can save time.
